(19) United States
(12) Patent Application Publication
(10) Pub. No.: US 2006/0015430 A1
(43) Pub. Date: Jan. 19, 2006

(54) Method for creating indices of forecasts of performance regarding financial markets

(75) Inventors: Gaetano Megale, Milano (IT); Claudio Grossi, Cremona (IT); Antonello Megale, Roma (IT)

Correspondence Address: SHERIDAN ROSS PC, 1560 BROADWAY, SUITE 1200, DENVER, CO, 80202, US

(73) Assignee: Progetica S.r.l., Milano (IT)

(21) Appl. No.: 11/078,310

(22) Filed: Mar. 14, 2005

(30) Foreign Application Priority Data
Jul. 15, 2004 (IT) MI2004A 001420

(51) Int. Cl. G06Q 40/00

(52) U.S. Cl. 705/35

(57) ABSTRACT

Described herein is a method for creating indices of forecasts of performance regarding financial markets, in which a number (p) of performances for each element of a number (m) of markets and/or financial tools are considered as unknown variables; the method comprising the following steps: definition of an objective function (FO) as the sum of the squares of the differences of the homologous elements of the correlation matrix calculated on the variables and of the correlation matrix supplied as forecast, and minimization of said objective function (FO) using a non-linear programming algorithm for identification of global optima so as to obtain said indices of forecasts of performance regarding financial markets.

The present invention relates to a method for creating indices of forecasts of performance regarding financial markets.

The forecasting activity regarding investment markets is probably the toughest task that a financial operator has to face. In this connection, it is natural for a forecast to be deemed “good” in the case where it is found to correspond to the actual situation. Unfortunately, the ex post verification of the goodness of a forecast makes much less sense than its ex ante evaluation. It is more useful to discriminate the qualities of a forecast before it is used, rather than to sanction the result of what has by now become a “post-vision”.

The forecasting activity regarding financial markets is extremely difficult for at least two good reasons.

The first reason is the fact that financial markets are governed by a basically random mechanism, as stated by random-walk theory, which is a special case of efficiency theories. In fact, financial markets vary according to new information and events which are, by definition, unforeseeable and which consequently determine their “random walks”. For this reason, the forecasts must be expressed in a probabilistic form and defined according to formally correct statistical models.

Deriving from the first reason is the second reason for difficulty, namely, the “quasi-structural” incapacity of the human brain to process information according to formally correct processes, as is demonstrated by cognitive psychology. In fact, the concept of probability frequently presents counter-intuitive aspects that are hard to grasp. The incapacity of the human brain to consider, at one and the same time, more than a maximum of up to 5±2 elements of information (the famous “magic number 7” of the cognitive psychologist Miller) renders the human processor a “machine that is naturally inclined to error”, at least as regards scientific processes of knowledge of reality.

The above two reasons consequently highlight the fact that a forecast can be evaluated as “good” a priori only if it is possible to appreciate that it has the maximum probability of occurrence and that it has been defined according to a formally correct statistical process. If this were not the case, it would be a matter of a mere, albeit respectable, “opinion”, which does not present the fundamental elements of the “quality”, namely, operative definition according to a scientific model, and verifiability and control.

There are currently widely used various methodologies that provide subjective forecasts on investment markets.

According to Modern Portfolio Theory, given a set of investment markets, in order to define an optimal allocation of investment, it is necessary for four quantities to be precisely defined: a) the time; b) the expected performances; c) the risk; and d) the correlations (or covariances).

a) The time is of course the period corresponding to the forecast itself and must be clearly specified: for example, “the first half of 2004”. Frequently, authoritative forecasts give periods that are ambiguously defined, such as, for example, “6-12 months”. In some cases, the time of the forecast (the future) may even be “swapped” with the time that has elapsed (the past). The use of ex post performance for defining ex ante performance is an incorrect approach, as, on the other hand, is testified by the empirical and theoretical evidence.

b) The performances must define the expected (i.e., most likely) percentage increase that each investment market considered, represented by an index, should achieve in the given period. Generally, said performances are insufficiently specified. Terms such as “the market is moving up (or down)” or “there won't be a marked rise (or drop)” or other sibylline expressions do not constitute elements that can be treated quantitatively. Furthermore, the forecasts of market trends may also assume a form of “consensus”, where the responses are the fruit of a kind of “democratic vote” representing a review of expert opinions, without, however, giving operative indications. Said general absence of quantitative specifications underlines the awareness that the forecast of market performance is intrinsically fallacious.

c) The risk is related, in absolute terms, to the possibility of market downturns in the period considered. In this connection, rarely is a favourable “forecast” regarding a market found to be accompanied by an indication of potential downturn. The reason for this is that, even though the forecast is favourable, it is necessary to consider the extent of its possible failure. Furthermore, the risk also represents the possibility of the performance differing (either positively or negatively) from the expected performance. In general, this is an element that remains hidden in market forecasts.

For example, when the possibility is expressed that the market will show an upturn in the next six months of 5% (expected performance), it would be necessary to accompany this indication with a “range of variation” or a “standard deviation” which might, in a quantitative manner, provide a warning regarding the error inherent in the forecast.

In the absence of an indication regarding the risk, the “forecast” assumes a deterministic, and hence antiscientific, character. This means that the “risk” of a forecast must be quantified, analysing all the market scenarios that could reasonably describe the future state (performance) and associate, to each of these, the corresponding probability of occurrence.

d) The correlations are related to the quantitative forecast of the interdependence between the performance of the set of markets considered over the same period. It is found that, in general, “forecasts” do not present this important indication, much less still if the “forecasts” propose as result “asset allocations”.

As is taught by Modem Portfolio Theory, it is evident that in proposing market combinations the role of correlations has an extraordinary impact. The failure to take into account forecasts regarding market covariation may lead to major harm from the efficiency standpoint and hence cause a “reduction in performance of asset allocation given the same risk” in favour of other alternatives or else an “increase in the risk given the same expected performance”. Application of Markowitz' methodology must therefore generate allocations that lie on the efficient boundary, calculated using the entire forecasting set-up, expressed in quantitative terms: time, performance, risk, and market correlations.

The purpose of the present invention is to overcome the limits of the known art by providing a method that will enable operators to increase appreciably the efficiency and effectiveness of forecasting activities regarding markets and/or investment products.

Presented in what follows are a number of definitions of mathematical-statistical tools adopted for implementation of the method according to the invention.

Quota Q

By “quota Q” is meant a numerical value attributed by a Body, Institution or, more generically, a provider of financial data (such as, for example, Morgan Stanley or JP Morgan), aimed at valorising, for example, a market index or a financial tool. Each quota Q refers to a given date.

Performance A

By “performance A” is meant the percentage variation in the quota Q referred to the same entity between two dates. Given an initial quota Qᵢₙ referring to an initial date tᵢₙ and a final quota Q_{fin} referring to a final date t_{fin}, with tᵢₙ<t_{fin}, the performance A in the period T=t_{fin}−tᵢₙ is calculated as follows:

$$A = \frac{{Q}_{fin} - {Q}_{in}}{{Q}_{in}} * 100 \qquad ( 1 )$$

Said value of performance A represents a percentage, in the sense that it assumes a meaning if it is followed by the percentage symbol “%”. Assigned to each performance as a date is the date t_{fin} corresponding to the final quota Q_{fin}. In this way, we obtain for each performance a pair (value A, date t_{fin}) to which the value of the performance refers.

Historical Series of Performances

The historical series of performances is an ordered sequence of performances A calculated on quotas Q with a given frequency. Once a given frequency k has been set (daily, weekly, monthly, etc.), in order to obtain a historical series of n performances, n performances (A₁, A₂, . . . , Aᵢ, Aᵢ₊₁, . . . , Aₙ) are calculated with the frequency k and ordered according to the dates of the performances themselves.

Contiguous performances in the historical series have the following property: the performance Aᵢ and performance Aᵢ₊₁ are constructed in such a way that the final quota Q_{fin} corresponding to the performance Aᵢ is equal to the initial quota Qᵢₙ corresponding the performance Aᵢ₊₁.

Forecast Series of Performances

The forecast series of performances has the same characteristics as a historical series, with the sole difference that the forecast series does not come from calculations on historical quotas but from a process based upon pseudo-random generation of values that must respect certain statistical constraints imposed. Said constraints are, in fact, the expression of the forecast of the future trends supplied by the user.

Capitalization Index I

Given a performance Aᵢ, the corresponding capitalization index Iᵢ is obtained as follows:

$${I}_{i} = 1 + \frac{{A}_{i}}{100} \qquad ( 2 )$$

Consequently, given a series of n performances (A₁, A₂, . . . , Aₙ), by applying the formula (2) a series of n capitalization indices (I₁, I₂, . . . , Iₙ) is obtained.

Yield On Period T R_{T}

Let T be a value representing a time period expressed with a certain unit of frequency k (daily, weekly, monthly, etc.). Given a series of performances of frequency k (A₁, A₂, . . . , Aᵢ, Aᵢ₊₁, . . . , Aₙ), made up of n elements such as to satisfy the relation given below:
T=n·k (3)
the yield on the period T in practice represents the total performance expressed by the series and is calculated according to the following relation:
R_{T}=(Πⱼ₌₁ⁿIⱼ−1)·100 (4)
where Iⱼ are the capitalization indices calculated for the n performances.
Standard Deviation σ

Given a series of n performances (x₁, x₂, . . . , xₙ), the “standard deviation” of the series represents the measurement of how much the individual values depart from the mean. This calculation is provided by:

$$σ = \sqrt{\frac{{\sum }_{i = 1}^{n} {( {x}_{i} - μ )}^{2}}{( n - 1 )}} \qquad ( 5 )$$

where μ designates the arithmetical mean of the n performances.
Correlation Matrix ρ

Given k series of performances all made up of n values, the correlation matrix is made up of the correlation coefficients calculated for each pair {(x₁, x₂, . . . , xₙ), (y₁, y₂, . . . , yₙ)} of the k series ρ_{i,j} with i and j ε [1 . . . k]. Each correlation coefficient is calculated according to the following expression:

$${ρ}_{x , y} = \frac{\frac{1}{n} {\sum }_{h = 1}^{n} ( {x}_{h} - {μ}_{x} ) ( {y}_{h} - {μ}_{y} )}{{σ}_{x} {σ}_{y}} \qquad ( 6 )$$

where μ is the arithmetic mean and a the standard deviation (calculated using formula (5)) of the values x of the first series and of the values y of the second series. Said functions generally require at input one or more real numerical values referred to as seeds, as will be described hereinafter.

### Generation of Pseudo-Random Values

Generation of pseudo-random values may be assigned to any algorithm for generation of continuous random variables that will produce real numbers in the range [0,1]. Almost all programming languages and numerical-simulation environments possess functions suitable for said purpose.

Global-Optimization Algorithm

For implementation of the method according to the invention, a global-optimisation algorithm is used. Among known global-optimisation algorithms the GLOBSOL software can be used, which implements a global-optimisation algorithm based upon a branch-and-bound method developed by R. Baker Kearfott at the Department of Mathematics of the University of Louisiana. The algorithm on which the GLOBSOL software is developed is contained in the book “Rigorous Global Search: Continuous Problems” published by Kluwer Academic Publishers, Dordrecht, Netherlands, in the series NON-CONVEX OPTIMISATION AND ITS APPLICATIONS and incorporated herein as reference.

Other global-optimisation algorithms may be found in the publication “Algorithms for Solving Non-linear Constrained and Optimisation Problems: The State of the Art” prepared by the COCONUT Project and available on the Internet link: http://solon.cma.univie.ac.at/˜neum/glopt/coconut/StArt.html

Method for Creating Indices of Forecasts of Performance

There follows a description of the method for processing data regarding performance forecasts for market and/or financial tools to obtain a synthetic index, according to the invention, hereinafter referred to as “Proxyntetica Forecast index”.

The user has at his disposal as starting data:

a number n of forecast performances of frequency k to be produced;

a forecasting time Tₚ, expressed as a multiple of the frequency k (i.e., Tₚ=p*k) and hence a number p of forecast performances;

a list of m markets and/or financial tools of which the corresponding forecast series are to be produced;

for each market and/or financial tool:
a forecasting Yield R_{Tp} forecast over the period Tₚ (R_{Tp} prevᵢ ∀ i ε [1 . . . m]), and
a forecasting Standard Deviation DS_{Tp} forecast over the period Tₚ (DS_{Tp} prevᵢ ∀ i ε [1 . . . m]); and

a forecasting correlation matrix ρ, between the m markets and/or financial tools, forecast over the period Tₚ (ρ(prev)_{i,j} ∀ i, j ε [1 . . . m]).

Consequently, the user performs the following steps:

sets possible seeds for the generation of m pseudo-random series of p values; and

selects an adequate non-linear programming algorithm for identification of global optima.

The user can resort to software packets available on the market, such as, for example, the one developed by GLOBSOL or can create a software of his own that implements any state-of-the-art global-optimisation algorithm, such as, for example, the ones described by the COCONUT Project.

The algorithm selected is set up with the data and parameters mentioned above, and hence is subjected to specific constraints (described in what follows) so as to calculate m series of performances formed by p elements. Said series of performances are appropriately replicated until n elements are obtained and enable a Proxyntetica Forecast index to be obtained for each of the m markets and/or financial tools.

For calculation of the Proxyntetica Forecast indices, considered as unknown variables of the problem are p performances for each element of the m markets and/or financial tools {(A₁₁, A₁₂, . . . , A₁ₚ), (A₂₁, A₂₂, . . . , A₂ₚ), . . . , (Aₘ₁, Aₘ₂, . . . , Aₘₚ)}.

Then, an objective function FO is defined as the sum of the squares of the differences of the homologous elements of the correlation matrix calculated on the variables and of the correlation matrix supplied as forecast, namely:

$$FO = {\sum }_{i , j = 1}^{m} {( {ρ ( var )}_{i , j} - {ρ ( prev )}_{i , j} )}^{2} \qquad ( 7 )$$

where ρ(var)_{i,j} are the elements of the correlation matrix of the variables of the problem and ρ(prev)_{i,j} are the elements of the correlation matrix of the m markets and/or financial tools supplied as forecast.
Calculation of the Proxyntetica Forecast Index

The algorithm is set up, implementing the steps listed below.

a) The p performances for each element of the m markets and/or financial tools {(A₁₁, A₁₂, . . . , A₁ₚ), (A₂₁, A₂₂, . . . , A₂ₚ), . . . , (Aₘ₁, Aₘ₂, . . . , Aₘₚ)} are considered as unknown variables of the problem.

b) The variables referred to in the previous point are initialized with pseudo-random values.

c) The objective function FO (7) is minimized using a global-optimization algorithm.

The algorithm is subjected to the following constraints:

1) the Yield R_{Tp} over the period Tₚ calculated for each of the m markets and/or financial tools representing the variables of the problem should be strictly equal to the corresponding values of Yield on the period Tₚ supplied as forecast, namely,
R_{Tp}(Aᵢ₁, Aᵢ₂, . . . , Aᵢₚ)=R_{Tp} prevᵢ ∀ i ε [1 . . . m]
where R_{Tp}(Aᵢ₁, Aᵢ₂, . . . , Aᵢₚ) is calculated according to the formula (4);

2) the Standard Deviation DS_{Tp} over the period Tₚ calculated for each of the m markets and/or financial tools representing the variables of the problem, according to relation (5), should be strictly equal to the corresponding values of Standard Deviation over the period Tₚ envisaged as forecast, namely,
DS_{Tp}(Aᵢ₁, Aᵢ₂, . . . , Aᵢₚ)=DSₚ prevᵢ ∀ the ε [1 . . . m]

Once said constraints have been set, the algorithm starts to work to yield at output a sequence of p values for each of the m Proxyntetica Forecast indices.

In order to obtain the n performances required for each element of the m markets and/or financial tools, the p performances found are replicated until a series of n elements is obtained.

Described in what follows are the properties and use of the Proxyntetica Forecast index.

The method according to the invention hence takes concrete form in the quantitative definition of a database made up of a series of performances corresponding to the markets and/or financial tools. Said database represents the formalized synthesis of the consistent set of the subjective forecasts made, where it is possible for the operator himself to govern the definition of the parameters of the database (the frequency—daily, weekly, monthly, etc.—and the number of data forming each series).

The method hence enables an appreciable increase in the efficiency and effectiveness of operator forecasting activities:

the efficiency of the method is ensured by the possibility of using software and/or algorithms already possessed for the statistical analyses and for processing of investment allocations that the operator normally carries out on the historical series of performances, in so far as it is the database that adapts to the software and not vice versa; and

the effectiveness of the method is considerably improved in so far as the model makes possible:

1) maximization of the profitability of the investment strategy, in the case of correctness of the operator forecasts thanks to a formally correct processing method that is not based upon objectively unfounded heuristic estimates; and

2) minimization of the risk of losses, in the case of forecasting error on the part of the operator, thanks to the possibility of duly monitoring the evolution of the investment strategy as compared to the expected one in order to acquire, in due time, signals of any possible divergence and hence prepare corrective measures.

Listed below are the main applications of use of the Proxyntetica Forecast index:

a) backing up the operator in defining, in a formally correct manner, his own forecasts on a set of markets and/or financial tools identified;

b) previously estimating the degree of forecasting risk, i.e., quantifying the possibility that the achievable yield may depart from the pre-set expectations of yield;

c) identifying investment strategies that, given the forecasts on individual markets, will maximize the expected yield, given the same forecasting risk of alternative choices, and/or will minimize the forecasting risk, given the same expected yield of alternative choices;

d) duly describing the expected trend, with a time definition as desired, of individual markets and optimal allocations;

e) structuring a rigorous system of control (risk management) that will enable monitoring of the specific risk of management activities in order to identify appropriate corrective action; and

f) evaluating the results of the management activities based upon the model in order to identify precisely the sources of errors committed, as well as their contribution to the total amount of error, and hence improve the subsequent forecasting process.

By way of non-exhaustive example, there follows a description of an application of the method according to the invention, with the aid of the annexed drawings, in which:

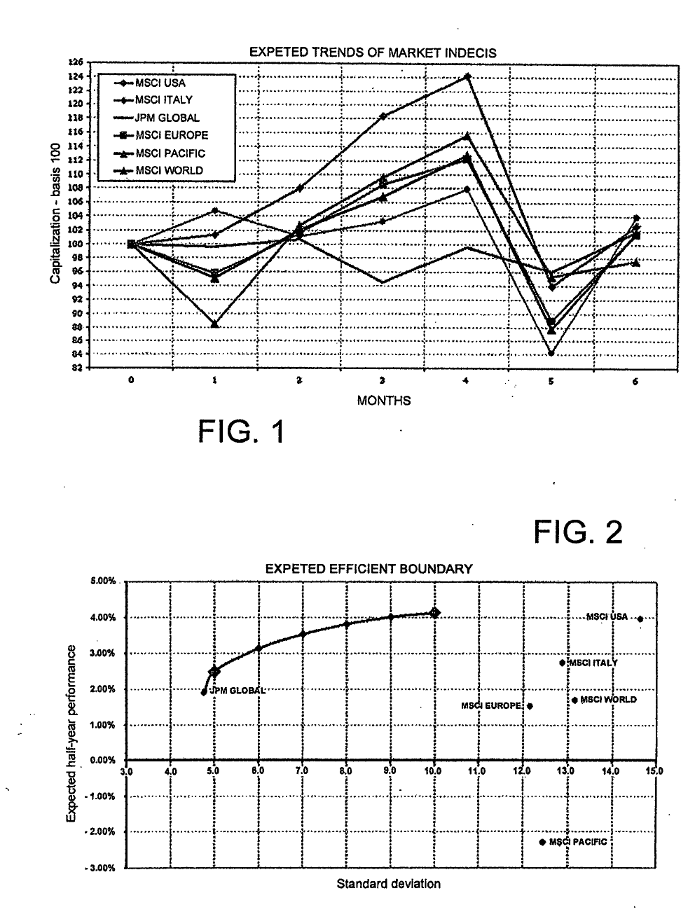

FIG. 1 is a diagram illustrating the expected trends of six market indices, calculated with the method according to the invention;

FIG. 2 is a diagram illustrating the expected efficient boundary, obtained from the expected trends of the market indices represented in FIG. 1;

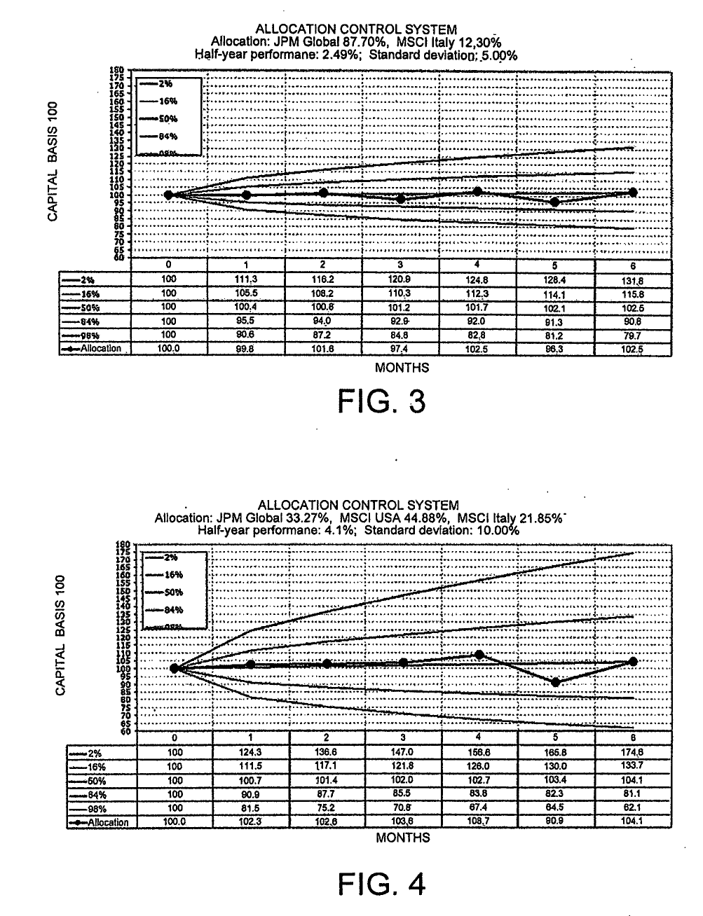

FIG. 3 is a diagram illustrating the allocation trend on the market of two indices: JPM Global and MSCI Italia; and

FIG. 4 is a diagram illustrating the allocation trend on the market of three indices: JPM Global, MSCI USA and MSCI Italia.

Given the forecasting time (the next six months), it is first of all necessary to describe the states (financial scenarios) that the markets may assume. Said activity specifically qualifies the operator who is involved in the analysis and subjective evaluation of the markets.

In each case, and with modalities that are most suitable to each individual operator, the inputs, expressed in a good form, which the operator has to state in regard to the subjective forecasts, appear in Tables 1 and 2 below. For example, Table 1 represents, for the individual indices, the expected performances and the corresponding standard deviations.

TABLE 1
OPERATOR INPUTS:
Ex ante Performance, Standard Deviation, Forecasting time

| | | | FORECASTING |
|---|---|---|---|
| | | STANDARD | TIME |
| MARKETS | PERFORMANCE | DEVIATION | (MONTHS) |
| JPM GLOBAL | 1.93% | 4.78% | 6 |
| MSCI USA | 3.97% | 14.63% | |
| MSCI EUROPE | 1.53% | 12.16% | |
| MSCI ITALY | 2.74% | 12.88% | |
| MSCI PACIFIC | −2.29% | 12.46% | |
| MSCI WORLD | 1.71% | 13.17% | |

To continue the example, appearing in Table 2, instead, are the expected correlations between the market indices analysed.

TABLE 2
OPERATOR INPUTS: Matrix of Correlations between Markets

| MARKETS | JPM GLOBAL | MSCI USA | MSCI EUROPE | MSCI ITALY | MSCI PACIFIC | MSCI WORLD |
|---|---|---|---|---|---|---|
| JPM GLOBAL | 1.00 | 0.65 | 0.46 | 0.36 | 0.31 | 0.57 |
| MSCI USA | 0.65 | 1.00 | 0.96 | 0.87 | 0.86 | 0.99 |
| MSCI EUROPE | 0.46 | 0.96 | 1.00 | 0.92 | 0.89 | 0.98 |
| MSCI ITALY | 0.36 | 0.87 | 0.92 | 1.00 | 0.83 | 0.90 |
| MSCI PACIFIC | 0.31 | 0.25 | 0.89 | 0.83 | 1.00 | 0.91 |
| MSCI WORLD | 0.57 | 0.99 | 0.98 | 0.90 | 0.91 | 1.00 |

Once the inputs have been defined, processing of the above data using the method according to the invention generates, over the period defined ex ante, a database of the indices (illustrated in Table 3) and a representation of the market trends, developed over the entire forecasting period (illustrated in FIG. 1).

TABLE 3
OUTPUT: MONTHLY PROXYNTETICA FORECAST PERFORMANCE SERIES

| Ex Ante | JPM GLOBAL | MSCI USA | MSCI EUROPE | MSCI ITALY | MSCI PACIFIC | MSCI WORLD |
|---|---|---|---|---|---|---|
| Month 1 | −0.39% | 4.73% | −4.27% | 1.32% | −11.46% | −4.89% |
| Month 2 | 1.10% | −3.38% | 6.15% | 6.67% | 15.97% | 7.28% |
| Month 3 | −6.08% | 2.07% | 6.88% | 9.53% | 6.70% | 4.73% |
| Month 4 | 5.31% | 4.52% | 3.39% | 4.91% | 5.56% | 5.57% |
| Month 5 | −3.51% | −21.93% | −20.75% | −24.31% | −17.56% | −22.18% |
| Month 6 | 6.05% | 23.35% | 14.11% | 9.30% | 2.48% | 15.85% |

In FIG. 1, the trends describe the typical (or expected) six-monthly evolution of the individual index in relation to the set of the trends of the other indices. Said trends express analytically the subjective forecast of the operator regarding the evolution of the individual markets. With this mass of information, obtained applying the method according to the invention, it is relatively simple to calculate the efficient boundary ex ante of the next six-monthly period (for example, with any allocation-optimization algorithm based upon the efficient-diversification principle developed by Markowitz) in order to achieve the best investment strategies. A representation of the expected efficient boundary is illustrated in FIG. 2.

From an analysis of FIG. 2 it is possible to isolate two optimal polar strategies that enable increase in the efficiency of investments, so increasing the yield at practically equal risk of JP Morgan Global and reducing the risk given the same yield of MSCI USA.

The investment strategies identified can thus be represented by a diagram that traces their evolution over time (from 0 to 6 months) as a function of the probabilities of acquisition of the result shown. Said diagram, which represents the investment-control system, is obtained in the following way:

given a series of m performances (A₁, A₂, . . . , Aₘ), a level of probability P, and s time intervals (T₁, T₂, . . . , Tₛ) each comprised between 1 and m,

calculate the complementary probability P*=100%−P;

for said complementary probability P*, calculate the corresponding point Z representing the abscissa with respect to which, by calculating the probability on a normal distribution with zero mean and unit standard deviation, the given probability is obtained;

calculate the geometrical mean Mg of the series of m capitalization indices (I₁, I₂, . . . , Iₘ) corresponding to the given series of m performances;

calculate the standard deviation DSᵢₙ of the logarithmic series (L₁, L₂, . . . , Lₘ) corresponding to the given series of m performances;

calculate the s values of the curve corresponding to the level of probability P according to the following formula:
C_{(P,T}_{ᵢ}₎=Mg^{T}_{ⁱ}*e^{(Z*DS}_{¹ⁿ}^{*\sqrt{Tsiⁱ})} (8)
where e is Napier's number and i ε [1, . . . s].

Defined as control system of probability P is the series of s values (C_{(P,T1)}, C_{(P,T2)}, . . . , C_{(P,Ts)}) obtained as described by formula (8).

The above calculations are hence carried out on the Proxyntetica Forecast indices. In addition, it is also possible to describe the expected trend, point by point, of the respective optimal allocations, and this enables an increase in the effectiveness of the investment-control system. Formula (8) is used to obtain the trend of the allocation that represents the control system of the allocation.

FIG. 3 represents the allocation-control system (formed by two indices: JPM Global and MSCI Italy), and FIG. 4 represents the allocation-control system (formed by three indices: JPM Global, MSCI USA and MSCI Italy). Appearing in the diagrams of FIGS. 3 and 4 is the allocation trend itself, which is obtained by applying formula (8) after the following variables have been set:

the series of performances equal to that of the benchmark;

5 levels of probability (2%, 16%, 50%, 84%, and 98%);

6 time intervals (1 month, 2 months, 3 months, 4 months, 5 months, and 6 months); and

the allocation performances corresponding to the six time intervals.

It is pointed out that the method enables formalization of subjective forecasts for identifying investment alternatives rationally in full awareness of the degree of forecasting risk. Of course, the profitability of the choices depends upon the correctness of the hypotheses, where the model can enable control of their adequacy for the effective evolution of the markets and the timely preparation of appropriate corrective measures. In this way, the model backing up the forecasting activities becomes an important aid to the risk-management functions, for a rigorous monitoring of the specific risk of management activities, with a preventive and corrective function.

In the case where it is desired to use software and/or algorithms for statistical analyses and for processing of investment allocations with constraints regarding the numerosity and periodicity of the historical series, it is possible to feed the database with Proxyntetica Forecast series appropriately treated to preserve the information itself and, at the same time, to adapt to the requirements of the software used. Table 4 gives, by way of example, the Proxyntetica Forecast series of Table 3 converted into series of sixty monthly observations, obtained by replicating, in sequence, the six performances identified, until a series with sixty observations is obtained.

TABLE 4
MONTHLY PROXYNTETICA FORECAST PERFORMANCE
SERIES CONVERTED INTO 60 OBSERVATIONS

| Ex Ante | JPM GLOBAL | MSCI USA | MSCI EUROPE | MSCI ITALY | MSCI PACIFIC | MSCI WORLD |
|---|---|---|---|---|---|---|
| Month 1 | −0.39 | 4.73 | −4.27 | 1.32 | −11.46 | −4.89 |
| Month 2 | 1.10 | −3.38 | 6.15 | 6.67 | 15.97 | 7.28 |
| Month 3 | −6.08 | 2.07 | 6.88 | 9.53 | 6.70 | 4.79 |
| Month 4 | 5.31 | 4.52 | 3.39 | 4.91 | 5.56 | 5.57 |
| Month 5 | −3.51 | −21.93 | −20.75 | −24.31 | −17.56 | −22.18 |
| Month 6 | 6.05 | 23.35 | 14.11 | 9.30 | 2.48 | 15.85 |
| Month 7 | −0.39 | 4.73 | −4.27 | 1.32 | −11.46 | −4.89 |
| Month 8 | 1.10 | −3.38 | 6.15 | 6.67 | 15.97 | 7.28 |
| Month 9 | −6.08 | 2.07 | 6.88 | 9.53 | 6.70 | 4.79 |
| Month 10 | 5.31 | 4.52 | 3.39 | 4.91 | 5.56 | 5.57 |
| Month 11 | −3.51 | −21.93 | −20.75 | −24.31 | −17.56 | −22.18 |
| Month 12 | 6.05 | 23.35 | 14.11 | 9.30 | 2.48 | 15.85 |
| Month 13 | −0.39 | 4.73 | −4.27 | 1.32 | −11.46 | −4.89 |
| Month 14 | 1.10 | −3.38 | 6.15 | 6.67 | 15.97 | 7.28 |
| Month 15 | −6.08 | 2.07 | 6.88 | 9.53 | 6.70 | 4.79 |
| Month 16 | 5.31 | 4.52 | 3.39 | 4.91 | 5.56 | 5.57 |
| Month 17 | −3.51 | −21.93 | −20.75 | −24.31 | −17.56 | −22.18 |
| Month 18 | 6.05 | 23.35 | 14.11 | 9.30 | 2.48 | 15.85 |
| Month 19 | −0.39 | 4.73 | −4.27 | 1.32 | −11.46 | −4.89 |
| Month 20 | 1.10 | −3.38 | 6.15 | 6.67 | 15.97 | 7.28 |
| Month 21 | −6.08 | 2.07 | 6.88 | 9.53 | 6.70 | 4.73 |
| Month 22 | 5.31 | 4.52 | 3.39 | 4.91 | 5.56 | 5.57 |
| Month 23 | −3.51 | −21.93 | −20.75 | −24.31 | −17.56 | −22.18 |
| Month 24 | 6.05 | 23.35 | 14.11 | 9.30 | 2.48 | 15.85 |
| Month 25 | −0.39 | 4.73 | −4.27 | 1.32 | −11.46 | −4.89 |
| Month 26 | 1.10 | −3.38 | 6.15 | 6.67 | 15.97 | 7.28 |
| Month 27 | −6.08 | 2.07 | 6.88 | 9.53 | 6.70 | 4.79 |
| Month 28 | 5.31 | 4.52 | 3.39 | 4.91 | 5.56 | 5.57 |
| Month 29 | −3.51 | −21.93 | −20.75 | −24.31 | −17.56 | −22.18 |
| Month 30 | 6.05 | 23.35 | 14.11 | 9.30 | 2.48 | 15.85 |
| Month 31 | −0.39 | 4.73 | −4.27 | 1.32 | −11.46 | −4.89 |
| Month 32 | 1.10 | −3.38 | 6.15 | 6.67 | 15.97 | 7.28 |
| Month 33 | −6.08 | 2.07 | 6.88 | 9.53 | 6.70 | 4.73 |
| Month 34 | 5.31 | 4.52 | 3.39 | 4.91 | 5.56 | 5.57 |
| Month 35 | −3.51 | −21.93 | −20.75 | −24.31 | −17.56 | −22.18 |
| Month 36 | 6.05 | 23.35 | 14.11 | 9.30 | 2.48 | 15.85 |
| Month 37 | −0.39 | 4.73 | −4.27 | 1.32 | −11.46 | −4.89 |
| Month 38 | 1.10 | −3.38 | 6.15 | 6.67 | 15.97 | 7.28 |
| Month 39 | −6.08 | 2.07 | 6.88 | 9.53 | 6.70 | 4.79 |
| Month 40 | 5.31 | 4.52 | 3.39 | 4.91 | 5.56 | 5.57 |
| Month 41 | −3.51 | −21.93 | −20.75 | −24.31 | −17.56 | −22.18 |
| Month 42 | 6.05 | 23.35 | 14.11 | 9.30 | 2.48 | 15.85 |
| Month 43 | −0.39 | 4.73 | −4.27 | 1.32 | −11.46 | −4.89 |
| Month 44 | 1.10 | −3.38 | 6.15 | 6.67 | 15.97 | 7.28 |
| Month 45 | −6.08 | 2.07 | 6.88 | 9.53 | 6.70 | 4.79 |
| Month 46 | 5.31 | 4.52 | 3.39 | 4.91 | 5.56 | 5.57 |
| Month 47 | −3.51 | −21.93 | −20.75 | −24.31 | −17.56 | −22.18 |
| Month 48 | 6.05 | 23.35 | 14.11 | 9.30 | 2.48 | 15.85 |
| Month 49 | −0.39 | 4.73 | −4.27 | 1.32 | −11.46 | −4.89 |
| Month 50 | 1.10 | −3.38 | 6.15 | 6.67 | 15.97 | 7.28 |
| Month 51 | −6.08 | 2.07 | 6.88 | 9.53 | 6.70 | 4.79 |
| Month 52 | 5.31 | 4.52 | 3.39 | 4.91 | 5.56 | 5.57 |
| Month 53 | −3.51 | −21.93 | −20.75 | −24.31 | −17.56 | −22.18 |
| Month 54 | 6.05 | 23.35 | 14.11 | 9.30 | 2.48 | 15.85 |
| Month 55 | −0.39 | 4.73 | −4.27 | 1.32 | −11.46 | −4.89 |
| Month 56 | 1.10 | −3.38 | 6.15 | 6.67 | 15.97 | 7.28 |
| Month 57 | −6.08 | 2.07 | 6.88 | 9.53 | 6.70 | 4.79 |
| Month 58 | 5.31 | 4.52 | 3.39 | 4.91 | 5.56 | 5.57 |
| Month 59 | −3.51 | −21.93 | −20.75 | −24.31 | −17.56 | −22.18 |
| Month 60 | 6.05 | 23.35 | 14.11 | 9.30 | 2.48 | 15.85 |

1. A method for creating indices of forecasts of performance regarding financial markets, wherein a number (p) of performances for each element of a number (m) of markets and/or financial tools are considered as unknown variables, the method comprising the following steps:
definition of an objective function (FO) as the sum of the squares of the differences of the homologous elements of the correlation matrix calculated on the variables and of the correlation matrix supplied as forecast; and
minimization of said objective function (FO) by means of a non-linear programming algorithm for identification of global optima, so as to obtain said indices of forecasts of performance regarding financial markets.

2. The method according to claim 1, wherein it further comprises the steps of:
entry of possible seeds for the generation of (m) pseudo-random series of (p) values; and
initialization of said variables with said pseudo-random values.

3. The method according to claim 1, wherein said algorithm for minimization of said objective function is subject to the following constraints:
the Yield (R_{Tp}) on the period Tₚ, calculated for each of the m markets and/or financial tools representing the variables of the problem, should be strictly equal to the corresponding values of Yield on the period Tₚ supplied as forecast; and
the Standard Deviation (DS_{Tp}) on the period Tₚ, calculated for each of the m markets and/or financial tools representing the variables of the problem, should be strictly equal to the corresponding values of Standard Deviation on the period Tₚ supplied as forecast.

4. The method according to claim 1, wherein said non-linear programming algorithm for identification of global optima is the algorithm developed by GLOBSOL.

5. The method according to claim 1, wherein said non-linear programming algorithm for identification of global optima is the algorithm developed by the COCONUT Project.

6. The method according to claim 1, wherein there are used as starting data:
a number (n) of forecasting performances of frequency (k) to be produced;
a forecasting time (Tₚ) expressed as multiple of the frequency (k) (i.e., Tp=p*k) and hence a number (p) of forecasting performances;
a list of (m) markets and/or financial tools of which the corresponding forecast series are to be produced;
for each market and/or financial tool:
a forecasting Yield (R_{Tp}) forecast over the period (Tₚ) (R_{Tp} prevᵢ ∀ i ε [1 . . . m]); and
a forecasting Standard Deviation (DS_{Tp}) forecast over the period (Tₚ) (DS_{Tp} prevᵢ ∀ i ε [1 . . . m]); and
a forecasting correlation matrix (ρ) between the m markets and/or financial tools forecast on the period Tₚ(ρ(prev)_{i,j} ∀ the, j ε [1 . . . m]).
